(19) United States
(12) Patent Application Publication
(10) Pub. No.: US 2004/0134001 A1
(43) Pub. Date: Jul. 15, 2004

(54) Toothbrushes with a replaceable head having a threaded connection

(75) Inventor: John Geoffrey Chan, Loveland, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH (US)

(21) Appl. No.: 10/659,788

(22) Filed: Sep. 10, 2003

Related U.S. Application Data
(60) Provisional application No. 60/410,853, filed on Sep. 13, 2002.

(51) Int. Cl. A61C 17/22

(52) U.S. Cl. 15/22.1

(57) ABSTRACT

A toothbrush having a replaceable head attachment is disclosed. The toothbrush includes a brush head that is releasably engaged to a handle portion and utilizes a threaded engagement configuration between the two components.

This application claims the benefit of U.S. Provisional Application No. 60/410,853, filed Sep. 13, 2002, the substance of which is incorporated herein by reference.

### FIELD OF THE INVENTION

The present invention relates to the field of toothbrushes, and more particularly, the invention relates to the field of electrically powered toothbrushes.

### BACKGROUND OF THE INVENTION

Electric toothbrushes are known that utilize a replaceable or interchangeable brush head which is releasably engageable with a handle or body portion. For example, U.S. Pat. No. 5,404,608 to Hommann discloses an electric toothbrush having a handle with a push-on brush component. U.S. Pat. No. 4,880,382 to Moret et al. and U.S. Pat. No. 5,435,034 to Bigler et al. disclose electric toothbrushes having brush heads that are replaceable and removable from a handle or body portion of the brush. Both the '382 patent and the '034 patent utilize a slotted engagement mechanism between the brush head and the handle portion of the brush. U.S. Pat. No. 5,465,444 to Bigler et al. describes an electric toothbrush having a brush head that is said to “slip-on” a handle portion.

Although satisfactory in many respects, a need exists for an electric toothbrush having a removable brush head that may be securely and easily engaged with a handle or body portion of the toothbrush that is more compact compact and robust.

### SUMMARY OF THE INVENTION

An electric toothbrush is provided. The electric toothbrush has a housing defining a hollow interior having a motor and a first shaft disposed therein that is operatively connected to the motor. The housing has an engagement member extending along a longitudinal axis of the housing from an end thereof. The engagement member includes a first thread helically extending the said engagement member.

A brush head is releasably connected to the handle. The brush head has a movable bristle carrier at a first end and a second shaft operatively connected to the movable bristle carrier. The brush head has a receiving region at a second end of the brush head opposite the first end. The receiving region has an engagement surface with a second thread helically extending along the annular engagement surface. The first thread and second thread form a threaded connection that releasably couples the brush head to the handle when one of the handle or the brush head is rotated about the longitudinal axis.

### BRIEF DESCRIPTION OF THE DRAWINGS

The present invention may take form in various components and arrangements of components, and in various techniques, methods, or procedures and arrangements of steps. The referenced drawings are only for purposes of illustrating preferred embodiments, they are not necessarily to scale, and are not to be construed as limiting the present invention.

It is believed that the present invention will be better understood from the following description taken in conjunction with the accompanying drawings in which:

FIG. 1 is a perspective view of a preferred embodiment electric toothbrush in accordance with the present invention.

FIG. 2 is a perspective view of the preferred embodiment toothbrush shown in FIG. 1 in a partially disassembled state in which the brush head is removed from the body portion of the brush.

FIG. 3 is a partial side view of the toothbrush shown in FIGS. 1 and 2 detailing the engagement of the brush head and the body or handle portion of the brush.

FIG. 4 is a detailed view illustrating the engagement and orientation of the brush head and handle portion of the toothbrush shown in FIG. 3, in which the components are separated from one another.

FIG. 5 is an end view of the brush head component shown in FIG. 4, taken with respect to line 5,5.

FIG. 6 is an end view of the handle portion of the brush assembly shown in FIG. 4 taken along line 6,6.

FIGS. 7A to 7C are cross-sectional side views showing engagement of first and second shafts.

### DETAILED DESCRIPTION OF THE PREFERRED EMBODIMENTS

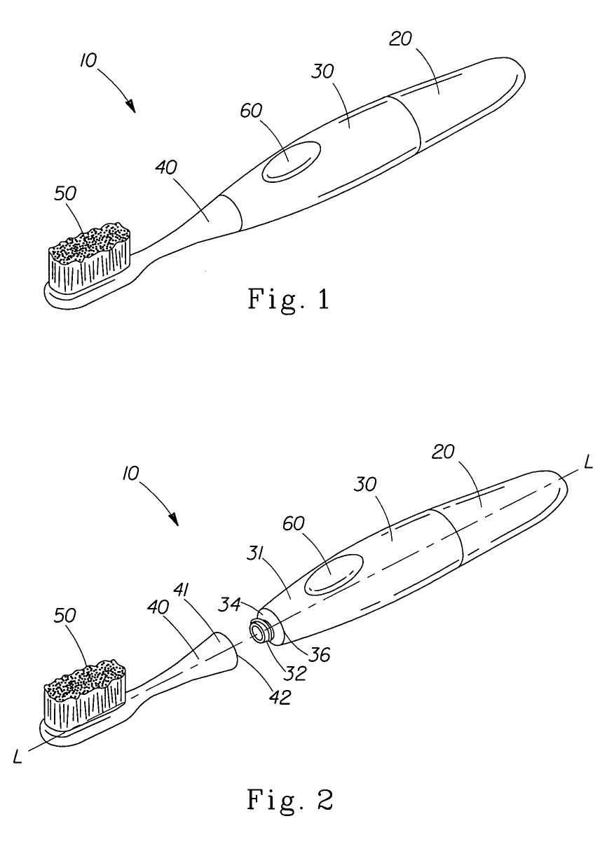

All patents and patent publications referenced herein, including U.S. Provisional Application No. 60/410,853, filed Sep. 13, 2002, are incorporated herein by reference. FIGS. 1 and 2 illustrate a preferred embodiment electric toothbrush 10 in accordance with the present invention. The preferred embodiment toothbrush 10 comprises a handle or body portion 30, an end cap 20 disposed at one end of the handle portion 30, and a brush head 40 disposed at an end opposite the end at which the end cap 20 is disposed. The handle 30 preferably defines a hollow interior region that is accessible from an open end defined at the end of the handle at which the end cap 20 is disposed. The hollow interior region defined within the handle 30 is also accessible from the end to which the brush head 40 is attached. The preferred embodiment toothbrush 10 also comprises a plurality of bristles 50 disposed on or near a distal-most end of the brush head 40. Most preferably, a movable bristle carrier is disposed on the end of the brush head that is driven by an electric motor disposed within the handle 30. The bristle carrier preferably supports and retains a collection of bristles that move along with the movable bristle carrier during operation of the electric toothbrush. Most preferably, the plurality of bristles 50 contain these movable bristles, and additionally include stationary or static bristles that are disposed along the brush head and preferably around the movable bristle carrier and its bristles. The preferred embodiment toothbrush 10 also includes an actuator or switch 60 accessible along the exterior of the handle 30 for actuating the motor disposed within the interior of the toothbrush 10. A drive mechanism operatively interconnects the motor and movable bristle carrier to impart movement, e.g. translational or oscillating movement, to the movable bristle carrier upon actuation of the motor by the switch 60. The present invention is not particularly directed to the bristles disposed on the brush head or the configuration of the movable bristle carrier and so extensive description of those aspects are not set forth herein. These aspects are the subjects of many of the Assignee's other patent applications and patents.

FIG. 2 illustrates the preferred embodiment electric toothbrush 10 in a partially disassembled state in which the brush head 40 is removed and separated from the handle portion 30. It can be seen that the handle portion 30 includes an engagement member 32 extending in a direction generally along the longitudinal axis of the toothbrush. The longitudinal axis is shown in FIG. 2 as axis L. Defined along this end of the handle 30 is a shoulder region formed from an annular surface 34 that extends from the main exterior of the housing 30, designated as the handle outer surface 31, to the engagement member 32. The corner or boundary between the generally smooth contoured handle outer surface 31 and the annular surface 34 is designated as corner 36. As will be appreciated, the corner 36 extends about the periphery of the handle 30 and generally separates the outer contoured surface of the handle 30 from the annular surface 34. The brush head 40 provides a distal end 42 which, upon engagement with the handle 30 of the toothbrush 10, generally borders or is immediately adjacent to the corner 36 of the handle 30.

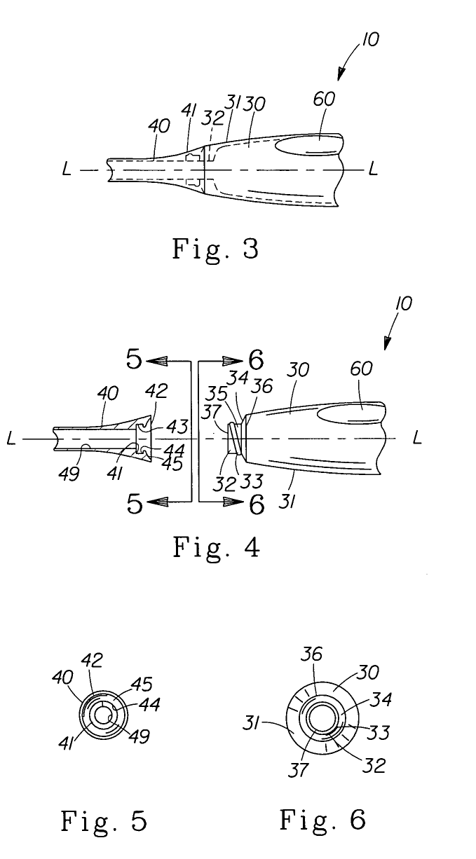

FIG. 3 is a detailed side view of a portion of the handle 30 and the brush head 40, further illustrating the engagement between those two components. FIG. 3 illustrates that the engagement member 32 is received and retained within a receiving region defined within an end of the brush head 40. Preferably, the outer surface of the brush head 40 is contoured and sloping in the same manner as the outer surface of the handle 30. The brush head outer surface is designated as 41 in the referenced figures. Most preferably, the outer contours of the two components, i.e. the brush head 40 and the handle 30, are such that when those components are engaged with each other as shown in FIG. 3, a single, continuous common surface is formed from the outer surfaces of the components, i.e. surfaces 31 and 41. That is, the degree of contour or slope of an outer surface of one of the components is continued and exhibited by the other component engaged thereto.

FIG. 4 details the engagement structures between the brush head 40 and the handle portion 30, and illustrates those components as separated from one another. Specifically, the handle or body portion 30 includes the annular surface 34, from which extends the engagement member 32. The engagement member 32 is preferably in the shape of a cylinder, although conical configurations are also encompassed by the present invention. The engagement member 32 preferably extends along and is concentrically disposed about the longitudinal axis L of the toothbrush. Defined along the cylindrically shaped engagement member 32 is a screw member or thread 33 that is oriented such that it extends generally radially outward from an outer surface 35 of the engagement member 32. The thread 33 helically extends along the length of the engagement member 32, or substantially so. The thread 33 has a major diameter, a minor diameter, a pitch diameter, and a pitch. The thread engages a corresponding thread 44 disposed on brush head 40. The thread is configured to facilitate engagement between a first shaft disposed within the handle 30 and a second shaft disposed within the brush head 40, as discussed more fully hereafter. The first and second shafts can reciprocate, rotate, oscillate, or gyrate to transmit motion from an electric motor in the handle to the movable bristle carrier disposed at the end of the brush head 40.

With regard to the brush head 40, a recessed receiving region is generally defined within the distal end 42 of that component. A sealing lip 45 extends around the periphery of the distal end 42 of the brush head 40. An annular engagement surface 43 having a complimentary screw member or thread 44 projecting from its cavity walls is provided within the receiving region, adjacent the sealing lip 45. That is, the thread 44 projects from the surface 43, toward the interior of the receiving region defined in part by the surface 43. The thread 44 helically extends along the annular engagement surface 43. The thread 44 engages to thereby form a threaded connection between the brush head 40 and handle 30. The thread 44 can be provided as either a male thread or a female thread as can the thread 33 of the engagement member 32. The brush head 40 further defines a channel 49 extending from the annular engagement surface 43 within its interior, and preferably extending co-linearly with the longitudinal axis L of the toothbrush 10.

FIG. 5 is an end view of the brush head 40. The brush head 40, as previously noted, includes a sealing lip 45 that extends inward from the distal end 42. The sealing lip 45 leads to the annular engagement surface 43. That surface, i.e. the annular engagement surface 43, extends between the sealing lip 45 and the channel 49 extending within the interior of the brush head. A stop surface 41 is provided between the entrance to the channel 49 and the annular engagement surface 43. The stop surface is preferably oriented and generally perpendicular to the longitudinal axis of the toothbrush 10.

FIG. 6 illustrates an end view of the preferred embodiment handle 30 of the brush 10. FIG. 6 illustrates the outer surface 31 of the handle 30 as it extends to the corner 36. FIG. 6 further illustrates the annular surface 34 extending between the corner 36 and the cylindrically shaped engagement member 32 having a thread 33 formed thereon. FIG. 6 also illustrates an annular sealing surface 37. The sealing surface is generally defined along the distal end of the engagement member 32.

Insertion of the engagement member 32 within that receiving region is achieved by rotating one of the handle 30 or the brush head 40 with respect to the other. Accordingly, upon insertion, the engagement member 32, and thus the handle 30, may not be withdrawn from the brush head 40. Withdrawal or separation of the components 30 and 40 is achieved by rotating, in an opposite direction, one component with respect to the other. It will be understood that the helical orientation of each of the threads 33 and 44 is the same so that one thread may slide or otherwise be translated past the other.

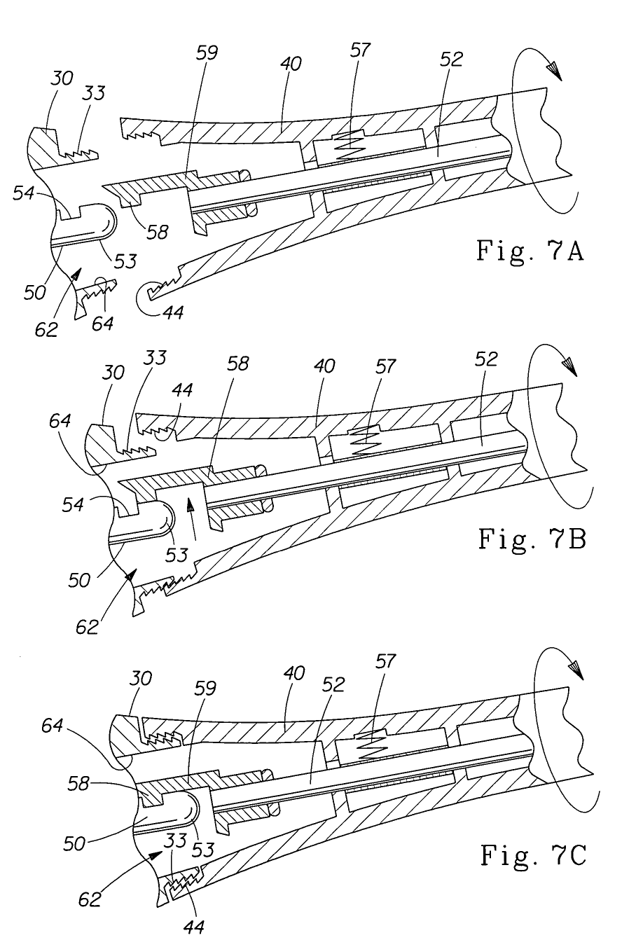

As previously noted, it is preferred that a motor, power source, and drive mechanism be disposed within the hollow interior region defined within the handle 30 of the preferred embodiment toothbrush. A wide array of drive motor and gearing configurations may be utilized in the preferred embodiment toothbrushes described herein. For example, various drive mechanisms described in U.S. Publication No. 20020162180A1 and U.S. Pat. Nos. 6,178,579; 6,189,693; 6,360,395; and 6,371,294 may be suitable. The drive mechanism includes a first shaft 50 (FIG. 7) disposed within the handle that is operatively connected to the motor. An interconnecting structure is provided that releasably couples the first shaft in the handle 30 with a second shaft 52 in the brush head 40 so that motion is transmitted from the motor (not shown) to the movable bristle carrier on the brush head 40. The interconnecting structure should both couple the first and second shafts and be compatible with the rotational movement associated with engagement of the threads 33 and 44.

Referring to FIG. 7, a preferred interconnecting structure for coupling the first shaft 50 in the handle 30 and the second shaft 52 of the brush head 40 that is suitable for use with the threads 33 and 44 is illustrated. The interconnecting structure couples the first and second shafts when the brush head 40 threadedly engages the handle 30. The interconnecting structure comprises a notch 54 on the first shaft 50 and a radially extending tab 58 that engages the notch 54 to couple the first and second shafts 50 and 52. The tab 58 extends from an arm 59 connected to the second shaft 52 that is offset from the centerline thereof. The tip 53 of the first shaft is substantially cylindrical in shape so that the tab 58 can easily traverse the outer surface of the first shaft as the brush head 40 is rotated through the engagement length of the threads 33 and 44. The distal most end of the first shaft 50 is also rounded or chamfered to facilitate guiding the tab 58 onto the outer cylindrical surface of the first shaft 50. The second shaft 52 should be flexible and resilient or otherwise deflectable enough to permit the extension 56 to be radially displaced, as best seen in FIG. 7B. A spring 57 can be provided in the brush head 40 to radially bias the second shaft 52 in order to accommodate the deflection of the second shaft 52. An annular gap 62 is provided between the first shaft 50 and the inner surface 64 of the handle 30 that is sufficient to permit the tab 58 and least a portion of said arm 59 to pass there through. The annular gap 62 preferably extends about the entire outer surface of the first shaft 50 (i.e., about the entire perimeter or circumference (if cylindrical) of the first shaft 50), although the gap 62 may extend about less where the brush head 40 is rotated less than 360° to engage the notch 54 and the tab 58. As previously discussed, however, it is preferred to rotate the brush head 40 at least about 360° about the longitudinal axis L to provide sufficient engagement between the threads 33 and 44. The pitch of the threads 33 and 44 is preferably selected to provide a smooth engagement between the notch 54 and the tab 58 (or other interconnecting structures releasably coupling the first and second shafts) as the brush head 40 is rotated and translated along the longitudinal axis L of the toothbrush. If the pitch is too low (i.e., too few threads per mm), the tab 58 and notch 54 might bind during engagement because the thread lead angle is too great. If the shafts reciprocate along the longitudinal axis L, the pitch should also be selected to accommodate the amount of travel associated with the first and second shafts so that engagement of the notch 54 and tab 58 will occur regardless whether the first or second shafts are at the beginning or end of their stroke. The pitch should also be selected to provide a reasonable amount of rotation about the longitudinal axis L so that excessive rotation of the handle 30 or brush head 40 is not required yet sufficient thread engagement is provided for strength. Preferably, the amount of rotation is between about 180° and about 540° about the longitudinal axis L of the toothbrush 10. In another embodiment, the pitch is selected to provide between about 270° and about 450° of rotation about the longitudinal axis L of the toothbrush 10. The pitch is preferably between about 1 and about 5 mm and more preferably between about 2 and about 3 mm. A square thread profile is preferred, although other thread profiles can be used.

Techniques known to those of skill in the art, such as injection molding, can be used to manufacture the toothbrush of the present invention. The housing and the brush head may be formed from a wide array of polymers. In the following description of the preferred polymer materials for use herein, the abbreviations that are commonly used by those of skill in the art to refer to certain polymers appear in parentheses following the full names of the polymers. The polymer is preferably polypropylene (“PP”), or may be selected from the group consisting of other commercially available materials, such as polystyrene (“PS”), polyethylene (“PE”), acrylonitrile-styrene copolymer (“SAN”), and cellulose acetate propionate (“CAP”). These materials may be blended with one or more additional polymers including a thermoplastic elastomer (“TPE”), a thermoplastic olefin (“TPO”), a soft thermoplastic polyolefin (e.g., polybutylene), or may be selected from other elastomeric materials, such as etheylene-vinylacetate copolymer (“EVA”), and ethylene propylene rubber (“EPR”). Examples of suitable thermoplastic elastomers herein include styrene-ethylene-butadiene-styrene (“SEBS”), styrene-butadiene-styrene (“SBS”), and styrene-isoprene-styrene (“SIS”). Examples of suitable thermoplastic olefins herein include polybutylene (“PB”), and polyethylene (“PE”).

The present invention may further utilize features, aspects, components, materials, and characteristics from one or more of the following published patent applications or issued patents: WO 01/29128; U.S. Pat. No. 6,000,083; U.S. Des. Pat. No. 432,312; U.S. Des. Pat. No. 433,814; U.S. Pat. No. 6,178,579; U.S. Pat. No. 6,189,693; U.S. Pat. No. 6,311,837; U.S. published patent application Ser. No. 2002/0032941; U.S. Pat. No. 6,360,395; and U.S. Pat. No. 6,371,294.

The embodiments described herein were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed is:

1. An electric toothbrush, comprising:
a housing defining a hollow interior having a motor and a first shaft disposed therein that is operatively connected to said motor, said housing having an engagement member extending along a longitudinal axis of said housing from an end thereof, said engagement member including a first thread helically extending about said engagement member; and
a brush head having a movable bristle carrier at a first end of said brush head and a second shaft operatively connected to said movable bristle carrier, said brush head having a receiving region at a second end of said brush head opposite said first end, said receiving region having an engagement surface with a second thread helically extending along said annular engagement surface, wherein said first thread and said second thread form a threaded connection that releasably couples said brush head to said handle when one of said handle or said brush head is rotated about said longitudinal axis.

2. The electric toothbrush of claim 1, wherein said first and second threads have a pitch and said pitch is between about 2 mm and about 3 mm.

3. The electric toothbrush of claim 1, wherein said first and second shafts reciprocate.

4. The electric toothbrush of claim 1, wherein said second shaft is deflectable.

5. The electric toothbrush of claim 4, wherein said first shaft has a cylindrically-shaped tip.

6. The electric toothbrush of claim 5, wherein said second shaft has a tab and said first shaft has a notch that engages said tab to couple said first shaft and said second shaft.

7. The electric toothbrush of claim 1, wherein one of said handle and said brush head is rotated between about 180° and about 540° to fully engage said first thread and said second thread.

8. The electric toothbrush of claim 1, wherein one of said handle and said brush head is rotated between about 270° and about 450° to fully engage said first thread and said second thread.

9. The electric toothbrush of claim 1, further comprising an arm attached to said second shaft, wherein said tab is disposed on said arm.

10. The electric toothbrush of claim 9, wherein handle has an annular gap between an outer surface of said first shaft and an inner surface of handle for receiving said tab and at least a portion of said arm and wherein said annular gap extends about the entire perimeter of said first shaft.

11. An electric toothbrush, comprising:
a housing defining a hollow interior having a motor and a first shaft disposed therein that is operatively connected to said motor, said housing having an engagement member extending along a longitudinal axis of said housing from an end thereof, said engagement member including a first thread helically extending about said engagement member;
a brush head having a movable bristle carrier at a first end of said brush head and a deflectable second shaft operatively connected to said movable bristle carrier, said brush head having a receiving region at a second end of said brush head opposite said first end, said receiving region having an engagement surface with a second thread helically extending along said annular engagement surface, wherein said first thread and said second thread form a threaded connection that releasably couples said brush head to said handle when one of said handle or said brush head is rotated about said longitudinal axis; and
wherein one of said handle and said brush head is rotated between about 180° and about 540° to fully engage said first thread and said second thread.

12. The electric toothbrush of claim 11, wherein said first and second threads have a pitch and said pitch is between about 2 mm and about 3 mm.

13. The electric toothbrush of claim 11, wherein said first and second shafts reciprocate.

14. The electric toothbrush of claim 11, wherein said first shaft has a cylindrically-shaped tip.

15. The electric toothbrush of claim 14, wherein said second shaft has a tab and said first shaft has a notch that engages said tab to couple said first shaft and said second shaft.

16. The electric toothbrush of claim 11, wherein one of said handle and said brush head is rotated between about 270° and about 450° to fully engage said first thread and said second thread.

17. The electric toothbrush of claim 11, further comprising an arm attached to said second shaft, wherein said tab is disposed on said arm.

18. The electric toothbrush of claim 17, wherein handle has an annular gap between an outer surface of said first shaft and an inner surface of handle for receiving said tab and at least a portion of said arm and wherein said annular gap extends about the entire perimeter of said first shaft.
